(19) United States
(12) Patent Application Publication
(10) Pub. No.: US 2026/0307269 A1
(43) Pub. Date: Oct. 8, 2026

(54) METHOD AND SYSTEM FOR CONTROLLING ROBOT POSE USING FORCE/TORQUE SENSOR-BASED POSE ESTIMATION

(71) Applicant: GWANGJU INSTITUTE OF SCIENCE AND TECHNOLOGY, Gwangju (KR)

(72) Inventors: Kyoobin LEE, Gwangju (KR); Joo Soon LEE, Gwangju (KR); Geon Hyup LEE, Gwangju (KR); Kang Min KIM, Gwangju (KR); Min Hwan KO, Gwangju (KR); Sang Jun NOH, Gwangju (KR)

(73) Assignee: GWANGJU INSTITUTE OF SCIENCE AND TECHNOLOGY, Gwangju (KR)

(21) Appl. No.: 19/537,317

(22) Filed: Feb. 11, 2026

(30) Foreign Application Priority Data
Apr. 3, 2025 (KR) 10-2025-0043239

(51) Int. Cl. B25J 13/08; B25J 9/16

(52) U.S. Cl. CPC B25J 13/088; B25J 9/1692

(57) ABSTRACT

Disclosed herein is a method for controlling a robot pose using force/torque sensor-based pose estimation, according to the present invention. The method may comprise: controlling, by using a robot gripping a peg, the robot in a direction in which the peg is inserted into a hole; detecting an initial contact state in which the peg contacts an initial position of the hole, and sensing initial data sensed by the contact in response to the initial contact state; controlling the robot such that the peg additionally contacts the hole at a position different from the initial position, and sensing additional data sensed by the additional contact; inputting the initial data and the additional data into a pre-trained pose estimation model.

### CROSS REFERENCE TO RELATED APPLICATION

The present application claims priority to Korean Patent Application No. 10-2025-0043239, filed Apr. 3, 2025, the entire contents of which are hereby incorporated by reference in its entirety.

### BACKGROUND

### Field

The present disclosure relates to a method and system for controlling a robot pose by using force/torque sensor-based pose estimation.

### Description of the Related Art

As a robot control technology develops, various robots that replace tasks performed by humans are appearing, and recently, technology development for precision work and assembly process automation utilizing a robot is being actively progressed. In particular, as utilization of a robot increases in a manufacturing and assembly environment, the importance of the pose control technology that enables a robot to autonomously assemble various objects through more precise work is increasing.

As described above, in order for a robot to perform precise manipulation in various environments, estimating a robot pose accurately, and controlling the robot based on the robot pose are essential. For example, among robot assembly technologies, a peg-in-hole task is a most basic assembly process, and is performed by a process in which a robot arm grips a peg that is a rod-shaped part and then inserts the peg into a hole. In order for a robot to successfully perform a peg-in-hole task, accurately estimating a relative pose between a peg and a hole and controlling a robot pose to perform the insertion are essential. However, in an actual environment, due to various causes, problems such as misalignment of a pose between a peg and a hole and jamming may occur.

A conventional peg-in-hole task using a robot may be performed in various methods such as, mainly, being performed by modeling a force and shape data for a part of a specific shape, or being performed such that a robot reinforces and learns an optimal peg-in-hole task while repeating trial-and-error, and recognizing poses of peg and hole using vision information and controlling a robot pose.

These conventional methods have problems in that scalability is low because, when a part of a new shape is added, a modeling process must be performed again, and a limit exists in extension of a shape because the number of trial-and-error required in a learning process increases exponentially, and reliability of a task is lowered due to being vulnerable to occlusion phenomenon, illumination change, image noise, and the like.

Accordingly, in order to solve these problems, a need exists for the robot control technology for a peg-in-hole task that may be robustly applied even in various shapes and a new environment.

### SUMMARY

The present disclosure is directed to providing a method and system capable of controlling a robot pose by using a force/torque sensor-based pose estimation model.

More specifically, the present disclosure is directed to providing a method and system for controlling a robot pose to perform a peg-in-hole task by using a pose estimation model that infers a relative pose of a peg and a hole from force/torque data.

Further, the present disclosure is directed to providing a method and system for controlling a robot pose using force/torque sensor-based pose estimation to which a Sim-To-Real adaptation technology capable of improving peg-in-hole task performance in an actual environment by using a pose estimation model trained in a virtual environment is applied.

In order to solve the above-described problems, the present invention proposes a method and system for controlling a robot pose by using a pose estimation model that estimates poses of peg and hole based on a force/torque sensor. There is provided a method for controlling a robot pose using force/torque sensor-based pose estimation, according to the present invention. The method may comprise: controlling a robot in a direction in which a peg is inserted into a hole by using the robot gripping the peg; detecting an initial contact state in which the peg contacts an initial position of the hole, and sensing initial data sensed by the contact in response to the initial contact state; controlling the robot such that the peg additionally contacts the hole at a position different from the initial position, and sensing additional data sensed by the additional contact; inputting the initial data and the additional data into a pre-trained pose estimation model, and acquiring a relative pose of the peg and the hole inferred by the pose estimation model; and controlling the pose of the robot based on the relative pose of the peg and the hole such that the peg is moved and inserted into the hole.

Further, the sensing of the additional data may comprise: sequentially rotating the peg by a preset number of times according to a preset direction; and sensing the additional data in response to each rotation of the peg sequentially rotating according to the preset direction.

Further, the initial data and the additional data may comprise at least one among force data and torque data generated in a contact state of the peg and the hole.

Further, the method may comprise: training the pose estimation model by using a virtual peg and a virtual hole corresponding to a plurality of different shapes in a virtual environment, and, in the training, by using training data including at least one among virtual force data and virtual torque data sensed by contact of the virtual peg and the virtual hole and ground-truth data including a ground-truth relative pose of the virtual peg and the virtual hole, the pose estimation model may be trained.

Further, the pose estimation model may comprise at least one among a first pose estimation model trained in the virtual environment and a second pose estimation model trained in an actual environment, and the first pose estimation model may infer the relative pose of the peg and the hole by using virtual contact data in the virtual environment, and the second pose estimation model may infer the relative pose of the peg and the hole by using actual contact data in the actual environment.

Further, the method may further comprise: updating the second pose estimation model by using the first pose estimation model.

The updating may comprise: converting the actual contact data into the virtual contact data such that the actual contact data corresponds to the virtual contact data; corresponding, by using a knowledge distillation technique, a virtual feature vector extracted in the first pose estimation model and an actual feature vector extracted in the second pose estimation model; and fine-tuning the second pose estimation model by using the actual contact data.

The sensing of the additional data may comprise: sensing the additional data with reference to an N+1-th contact performed as the robot pose is controlled based on the relative pose of the peg and the hole inferred at an N-th contact of the peg.

There is provided a system for controlling a robot pose using force/torque sensor-based pose estimation, according to the present invention. The system may comprise: a communication unit configured to communicate with a robot; and a control unit configured to control the robot in a direction in which a peg is inserted into a hole by using the robot gripping the peg, in which the control unit may: detect an initial contact state in which the peg contacts an initial position of the hole; sense initial data sensed by the contact in response to the initial contact state; control the robot such that the peg additionally contacts the hole at a position different from the initial position; sense additional data sensed by the additional contact; input the initial data and the additional data into a pre-trained pose estimation model; acquire a relative pose of the peg and the hole inferred by the pose estimation model; and control the pose of the robot based on the relative pose of the peg and the hole such that the peg is moved and inserted into the hole.

Further, there is provided a method for controlling a robot pose using force/torque sensor-based pose estimation, according to the present invention. The method may comprise: controlling a robot in a direction in which a peg is inserted into a hole by using the robot gripping the peg; detecting a first contact state in which the peg contacts the hole, and sensing first contact data sensed by the first contact; sensing second contact data sensed by second contact in a second contact state in which the peg is moved and the peg and the hole contact at another position; inferring a relative pose of the peg and the hole by inputting the first contact data and the second contact data and peg movement amount from the first contact state to the second contact state into a pose estimation model; and sequentially controlling movement of the peg while comparing the relative pose with a target pose, such that the peg is inserted into the hole.

Further, the peg movement amount may comprise at least one among position change amount data of the peg and direction change amount data of the peg due to movement of the peg from the first contact state to the second contact state.

The sequential controlling of the movement of the peg may comprise: determining, in response to the movement of the peg, whether the relative pose of the peg and the hole satisfies the target pose; and continuously changing a robot pose until the relative pose satisfies the target pose by using a determination result.

There is provided a system for controlling a robot using force/torque sensor-based pose estimation, according to the present invention. The system may comprise: a communication unit configured to communicate with a robot; and a control unit configured to control the robot in a direction in which a peg is inserted into a hole by using the robot gripping the peg, in which the control unit may: detect a first contact state in which the peg contacts the hole; sense first contact data sensed by the first contact; sense second contact data sensed by second contact in a second contact state in which the peg is moved and the peg and the hole contact at another position; infer a relative pose of the peg and the hole by inputting the first contact data and the second contact data and peg movement amount from the first contact state to the second contact state into a pose estimation model; and sequentially control movement of the peg while comparing the relative pose with a target pose, such that the peg is inserted into the hole.

The method and system for controlling a robot pose using force/torque sensor-based pose estimation according to the present invention, by estimating a relative pose of the peg and the hole by using at least one among force data and torque data sensed by contact between the peg and the hole, may minimize performance degradation due to external environment factors, and may improve assembly performance of a robot in various industrial sites.

Further, the method and system for controlling a robot pose using force/torque sensor-based pose estimation according to the present invention, by updating the pose estimation model applied to the actual environment by using the pose estimation model trained in the virtual environment, may perform a high degree-of-freedom peg-in-hole task for a new shape not trained in the actual environment.

Further, the method and system for controlling a robot pose using force/torque sensor-based pose estimation according to the present invention, by training the pose estimation model by using the peg and the hole having various shapes in the virtual environment, may replace a process of directly collecting data in the actual environment, and may minimize cost and time required for building the pose estimation model.

The present invention is not directed merely to abstract decision-making or mathematical estimation of poses, but to improving internal operation of a robotic control system by integrating force/torque sensor data into an iterative pose estimation and control pipeline.

In particular, the disclosed method modifies how a robot controller detects contact states, processes multi-axis force and torque data, infers relative poses, and incrementally updates robot motion, thereby enabling stable and precise insertion control that cannot be achieved by conventional vision-based or rule-based control techniques.

### BRIEF DESCRIPTION OF THE DRAWINGS

FIG. 1 is a conceptual diagram for describing a system for controlling a robot pose using force/torque sensor-based pose estimation according to the present invention.

FIG. 2 is a conceptual diagram for describing a peg-in-hole task according to the present invention.

FIG. 3 is a flowchart for describing a method for controlling a robot pose using force/torque sensor-based pose estimation according to the present invention.

FIG. 4 is a conceptual diagram for describing a process of sensing a contact state and sensing data according to the present invention.

FIG. 5 is a conceptual diagram for describing a process of inferring a relative pose of peg and hole by using a pose estimation model according to the present invention.

FIG. 6A and FIG. 6B are conceptual diagrams for describing a Sim-to-Real adaptation process according to the present invention.

FIG. 7 is a conceptual diagram for describing a process of controlling a robot pose through force/torque sensor-based continuous pose estimation according to the present invention.

FIG. 8 is a flowchart for describing a method for controlling a robot pose through force/torque sensor-based continuous pose estimation according to the present invention.

FIG. 9 is a conceptual diagram for describing a process of contact data sensing and peg movement amount calculation according to the present invention.

FIG. 10 is a conceptual diagram for describing a pose estimation model according to the present invention.

### DETAILED DESCRIPTION OF THE EMBODIMENTS

Hereinafter, exemplary embodiments disclosed in the present specification will be described in detail with reference to the accompanying drawings. The same or similar constituent elements are assigned with the same reference numerals regardless of reference numerals, and the repetitive description thereof will be omitted. The suffixes "module", "unit", "part", and "portion" used to describe constituent elements in the following description are used together or interchangeably in order to facilitate the description, but the suffixes themselves do not have distinguishable meanings or functions. In addition, in the description of the exemplary embodiment disclosed in the present specification, the specific descriptions of publicly known related technologies will be omitted when it is determined that the specific descriptions may obscure the subject matter of the exemplary embodiment disclosed in the present specification. In addition, it should be understood that the accompanying drawings are provided only to easily understand the embodiments disclosed in the present specification, and the technical teachings disclosed in the present specification are not limited by the accompanying drawings, and includes all alterations, equivalents, and alternatives that are included in the teachings and the technical scope of the present invention.

The terms including ordinal numbers such as "first," "second," and the like may be used to describe various constituent elements, but the constituent elements are not limited by the terms. These terms are used only to distinguish one constituent element from another constituent element.

When one constituent element is described as being "coupled" or "connected" to another constituent element, it should be understood that one constituent element can be coupled or connected directly to another constituent element, and an intervening constituent element can also be present between the constituent elements. When one constituent element is described as being "coupled directly to" or "connected directly to" another constituent element, it should be understood that no intervening constituent element exists between the constituent elements.

Singular expressions include plural expressions unless clearly described as different meanings in the context.

In the present application, it should be understood that terms "including", "having", and the like are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

The present invention relates to a method and system capable of controlling a robot pose by using a force/torque sensor-based pose estimation model. More specifically, the present invention relates to a method and system for enabling a robot to perform a peg-in-hole task by using a pose estimation model that estimates poses of a peg and a hole from data acquired by using a force/torque sensor provided in the robot. Here, “peg-in-hole” may mean an assembly task of precisely inserting peg that is a rod-shaped part, into a part including a hole (or opening). Hereinafter, for convenience of description, an entire part including at least one hole (e.g., a body including a hole) is referred to as “hole”, and “a peg is inserted into a hole” means that a peg is inserted into at least one hole (or opening) included in the hole.

A robot according to the present invention may include at least one manipulator (or, a robot arm) and the like, and may perform a peg-in-hole task. Here, “manipulator” is a device such as a mechanical arm that manipulates an object in a robot and performs a specific task, and the manipulator may perform various tasks in a three-dimensional space based on a rotation and movement range of joints. In a manipulator of a robot of the present invention, an end effector may be attached, and the end effector may include a gripper capable of gripping a peg.

A robot 10 according to the present invention may mean all robots including a manipulator, and may also mean an industrial robot such as a robot arm including only a manipulator. Accordingly, hereinafter, for convenience of description, a manipulator control and a robot 10 control may be used interchangeably, and the manipulator control and the robot control may be understood as having the same meaning.

In a process in which the robot 10 according to the present invention grips a peg and inserts the peg into a hole, the peg and the hole may contact, and by contact, a contact force may occur. Here, “contact force” may mean at least one among a force in an X-axis direction, a force in a Y-axis direction, a force in a Z-axis direction, a torque (or, a turning (or twisting, rotational) force) with respect to an X-axis, a torque with respect to a Y-axis, and a torque with respect to a Z-axis, which occurs as the peg gripped by the robot contacts the hole. Further, at least one sensor (e.g., a force/torque sensor) provided in the robot 10 according to the present invention may sense force data and torque data corresponding to the contact force.

In the present invention, by using a pre-trained pose estimation model that infers a relative pose of the peg and the hole from the force data and the torque data, the present invention proposes a method of performing a peg-in-hole task such that the peg gripped by the gripper is inserted into the hole, by controlling at least one among a position and a direction of the gripper provided in a manipulator of the robot.

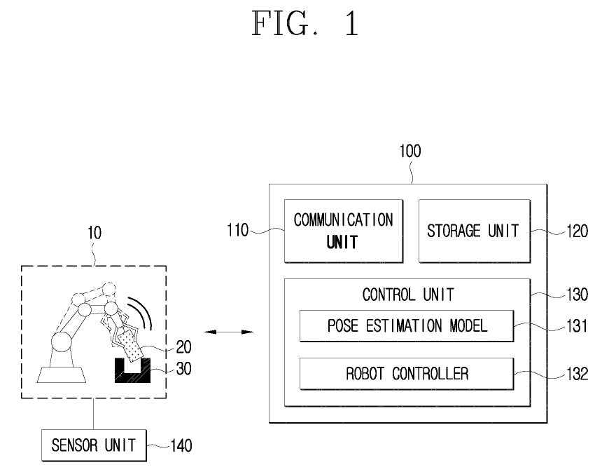

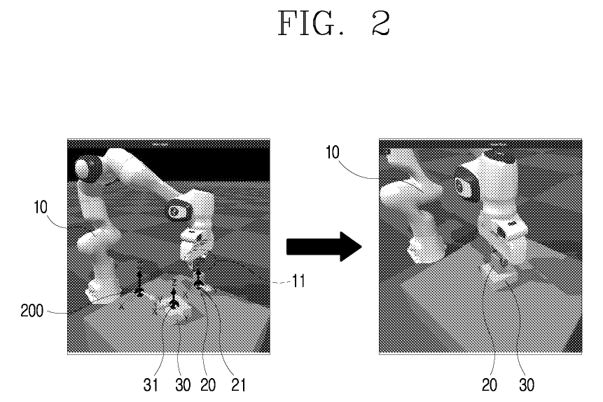

In the above, the robot pose control using the force/torque sensor-based pose estimation according to the present invention has been described overall, and such may be implemented by a system for controlling a robot pose using force/torque sensor-based pose estimation described below. Hereinafter, with reference to FIG. 1 and FIG. 2, a system for controlling a robot pose using force/torque sensor-based pose estimation according to the present invention will be described in detail. FIG. 1 is a conceptual diagram for describing a system for controlling a robot pose using force/torque sensor-based pose estimation according to the present invention. FIG. 2 is a conceptual diagram for describing a peg-in-hole task according to the present invention.

As illustrated in FIG. 1, a system 100 for controlling a robot pose using force/torque sensor-based pose estimation (hereinafter, is referred to as a “pose control system”), according to the present invention, may include at least one among a communication unit 110, a storage unit 120, and a control unit 130. Further, the control unit 130 according to the present invention may include at least one among a pose estimation model 131 and a robot controller 132. In this case, the pose control system 100 according to the present invention is not limited to the above-described constituent elements, and may further include a constituent element(s) that performs a role that is the same as or similar to a function according to the description of the present specification.

Meanwhile, the pose control system 100 may exist inside a server built (or constructed) to perform a specific purpose (for example, robot pose control) (hereinafter, referred to as a server), and may also exist as a device separate from the server. When the pose control system 100 exists inside the server, the pose control system 100 according to the present invention may control a robot pose through at least one constituent element among the communication unit 110, the storage unit 120, and the control unit 130 positioned inside the server, or through modules performing functions similar to the respective constituent elements.

The communication unit 110 according to the present invention may be connected with the robot 10, a central server, a device, and at least one network and the like through a wireless or wired network, and may be configured to receive or transmit overall data and information necessary for an operation of the pose control system 100 according to the present invention. Here, the robot 10 may mean at least one robot among an industrial robot arm, a collaborative robot (Co-Bot), a mobile manipulator, and a humanoid robot.

The robot 10 according to the present invention may include a sensor unit 140, and various sensors may be provided in the sensor unit 140. For example, the sensor unit 140 may include at least one sensor among a 6-axis F/T (force/torque) sensor, a lidar sensor, an infrared sensor, an ultrasonic sensor, a temperature sensor, a pressure sensor, a thermal detection sensor, a height sensor, an obstacle detection sensor, a camera, a motor encoder, an inertial sensor, and a 3D scanner.

The communication unit 110 may include at least one communication module capable of performing wireless communication and wired communication between the pose control system 100 and a communication target (e.g., robot). In addition, the communication unit 110 may include a communication module for connecting the pose control system 100 to at least one network. Specifically, the communication unit 100 may communicate with the robot 10, and may transmit and receive information related to pose control of the robot 10.

Meanwhile, the communication unit 110 may support various communication methods according to a communication standard of a communicating device. For example, the communication unit 110 may be configured to perform the communication using at least one among wireless LAN (WLAN), wireless-fidelity (Wi-Fi), wireless-fidelity (Wi-Fi) direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), fifth generation mobile telecommunications (5G), Bluetooth™, Radio Frequency Identification (RFID), infrared communication (Infrared Data Association; IrDA), ultra-wideband (UWB), ZigBee, near field communications (NFC), and wireless universal serial bus (wireless USB) technologies.

Next, the storage unit 120 may be configured to store various information related to the present invention. In the present invention, the storage unit 120 may be provided in the pose control system 100 itself, or alternatively, at least a part of the storage unit 120 may mean a database (DB).

The storage unit 120 may include one or more non-transitory computer-readable storage media that may be read and/or accessed by at least one processor. The one or more computer-readable storage media may include volatile and/or non-volatile storage constituent elements such as optical, magnetic, organic, or other memory or disk storage devices. In some examples, the storage unit 120 may be implemented by using a single physical device (e.g., a single optical, magnetic, organic, or other memory or disk storage device), whereas, in other examples, the storage unit 120 may be implemented by using a plurality of physical devices.

The storage unit 120 may include computer-readable directives and additional data. The storage unit 120 may include a repository required to perform at least a part of the methods and technologies described in this specification and/or at least a part of the functions of devices and networks.

Further, at least a part of the storage unit 120 may be cloud storage or a cloud server. That is, it may be understood that the storage unit 120 is sufficient as a space in which information necessary for the operation of the pose control system 100 according to the present invention is stored, and there is no limitation on a physical space.

In the storage unit 120, sensing data sensed by using a sensing unit 140 provided in the robot 10 may be stored. As an example, in the storage unit 120, at least one among force data and torque data generated by contact between a peg 20 and a hole 30 may be stored. Also, in the storage unit 120, at least one among movement amount of the peg 20 moved by the robot 10 and a movement trajectory may be sensed and stored.

In the storage unit 120, instructions for an operation of the pose estimation model 131 may be stored. Here, “pose estimation model 131” may mean an artificial intelligence model that estimates a relative pose (or position) of the peg 20 with respect to the hole 30 based on data sensed from the sensor unit 140 provided in the robot. For example, the pose estimation model 131 according to the present invention may include at least one among a multi-layer perceptron (MLP)-based model, a transformer-based model, a convolutional neural network (CNN)-based model, a recurrent neural network (RNN)-based model, and a graph neural network (GNN)-based model. The pose estimation model 131 according to the present invention is not limited to the above-described artificial intelligence model, and may further include an artificial intelligence model that performs the same function as the pose estimation model according to the present invention. Further, the pose estimation model 131 stored in the storage unit 120 may include at least one among a first pose estimation model trained in a virtual environment and a second pose estimation model trained in an actual environment.

Next, the control unit 130 may be configured to control an overall operation of the pose control system 100 related to the present invention. The control unit 130 may process a signal, data, information, and the like input or output through the above-described constituent elements, or may provide or process appropriate information and functions to a user.

As illustrated in FIG. 2, the control unit 130 may control a pose of the robot 10 such that the peg 20 is inserted into the hole 30. In this case, the control unit 130 may control the robot through the robot controller 132 such that the peg applies a preset magnitude (e.g., 10N) of force in a Z-axis direction with respect to the hole. The control unit 130 may sense force data and torque data generated as a preset magnitude of force in a Z-axis direction is applied.

More specifically, the control unit 130 according to the present invention may sense the contact force generated by contact between the peg and the hole by using the sensor unit 140 provided in the robot 10. Here, “contact force” may mean at least one among a force in an X-axis direction, a force in a Y-axis direction, a force in a Z-axis direction, a torque (or, a turning (or twisting, rotational) force) with respect to an X-axis, a torque with respect to a Y-axis, and a torque with respect to a Z-axis, which occurs as the peg gripped by the robot contacts the hole.

The force data and the torque data used in the present invention are physical sensor signals generated by actual contact between the peg and the hole, and are continuously acquired in real time from a force/torque sensor mounted on the robot manipulator.

Accordingly, the pose estimation and robot pose control processes according to the present invention are grounded in physical interaction data generated during contact, rather than being based on abstract numerical computation or purely algorithmic inference.The control unit 130 may detect an initial contact state in which the peg contacts an initial position of the hole, and may sense initial data including at least one among force data and torque data generated by initial contact by using the sensor unit 140 provided in the robot 10.

Further, the control unit 130 may control the robot to sequentially rotate (or, move) the peg according to a preset direction by a preset number of times, and may sense additional data including at least one among force data and torque data generated by additional contact in response to each rotation (or, movement) of the peg.

The control unit 130 may input the sensed initial data and the additional data to the pose estimation model, and may estimate a relative pose between the peg and the hole in the initial position with respect to the hole. Hereinafter, for convenience of description, “relative pose between a peg and a hole in an initial position with respect to the hole” may also be referred to as “relative pose of a peg and a hole”.

In order to estimate a relative pose according to the present invention, the control unit 130 may use relative coordinates of the peg and the hole. More specifically, in a world coordinate system 200, according to a reference point (or, an origin), poses of the peg and the hole are changed, thereby, it may be understood that it is difficult to accurately estimate poses of the peg and the hole.

Accordingly, the control unit 130 may calculate a relative pose of the peg and the hole by using a coordinate system 21 of the peg and a coordinate system 31 of the hole. Specifically, in a state in which the peg is inserted into the hole, the control unit 130 may set a common origin of the coordinate system 21 of the peg and the coordinate system 31 of the hole, and may infer the relative pose including a position and a direction of the peg with respect to the hole by using the common origin. Further, based on an initial pose of the peg in an initial contact state and relative pose of the peg and the hole, the control unit 130 may insert the peg into the hole by controlling at least one among a position and a direction of the peg.

The relative pose according to the present invention is defined as a quantitative representation including both a relative position and a relative orientation of the peg with respect to the hole, expressed in a coordinate system of the hole.

The relative pose is generated as machine-readable numerical data directly used as an input for robot motion control, rather than as an abstract estimation result or visual reference.

That is, the control unit 130 may infer a relative pose of the peg and the hole by inputting initial data corresponding to initial contact and additional data corresponding to each of a preset number of additional contacts into the pose estimation model 131. Further, from a pose of the peg in an initial position, the control unit 130 may control a robot pose such that the peg is inserted into the hole by reversely moving (or, rotating) by an inferred relative pose.

Meanwhile, by using a first pose estimation model trained in a virtual environment and a second pose estimation model trained in an actual environment, the control unit 130 may apply the pose estimation model trained in the virtual environment to the actual environment. In the present invention, due to an error generated by a domain gap between the virtual environment and the actual environment, force data and torque data of the virtual environment and the actual environment may show different aspects under the same condition. Here, “domain gap” may mean a difference of force data and torque data distribution existing between two data domains (e.g., a virtual environment-an actual environment).

Accordingly, the control unit 130 may update the second pose estimation model trained in the actual environment by using the first pose estimation model trained in the virtual environment. More specifically, in order to prevent performance degradation occurring when the first pose estimation model trained in the virtual environment is applied to the actual environment, the control unit 130 may reduce a domain gap between the virtual environment and the actual environment. Here, “domain gap” may mean a difference of force and torque data distribution existing between two data domains (e.g., a virtual environment-an actual environment).

The control unit 130 may reduce a domain gap between the virtual environment and the actual environment by updating the second pose estimation model by using the first pose estimation model. Further, by using force data and torque data collected in the actual environment, the control unit 130 may fine-tune the pose estimation model trained in the actual environment.

Meanwhile, based on peg movement amount and force data and torque data, the control unit 130 may gradually control a robot pose such that the peg is inserted into the hole by repeatedly inferring a relative pose of the peg and the hole. More specifically, the control unit 130 may detect a first contact state in which the peg contacts the hole, and may sense first contact data sensed by first contact. Further, in a second contact state in which the peg and the hole contact at another position by moving the peg, the control unit 130 may sense second contact data sensed by second contact.

The control unit 130 may infer a relative pose of the peg with respect to the hole by using the first contact data and the second contact data, and peg movement amount from the first contact state to the second contact state. Further, the control unit 130 may sequentially control movement of the peg such that the peg is inserted into the hole while comparing a relative pose with a target pose.

Meanwhile, the control unit 130 may include one or more processors, and these processors may include one or more general-purpose processors and/or one or more specialized processors (e.g., a digital signal processor, a tensor processing unit (TPU), a graphics processing unit (GPU), a neural network processing unit (NPU), an application-specific integrated circuit (ASIC), etc.). The one or more processors may be configured to execute instructions, computer-readable directives, and/or other commands described in the present specification stored (or included) in the storage unit 120. The pose control system 100 may perform the data processing described below by cooperation between a memory and at least one processor. The processor, by using data and information stored in the memory, may perform a series of operations and data processing. Here, “a memory” may be a configuration of the storage unit 120, and “a processor” may be used interchangeably with the control unit 130.

In the above, the pose control system 100 of the present invention has been described, and the pose control system 100 may be implemented based on a method for controlling a robot pose using force/torque sensor-based pose estimation described below.

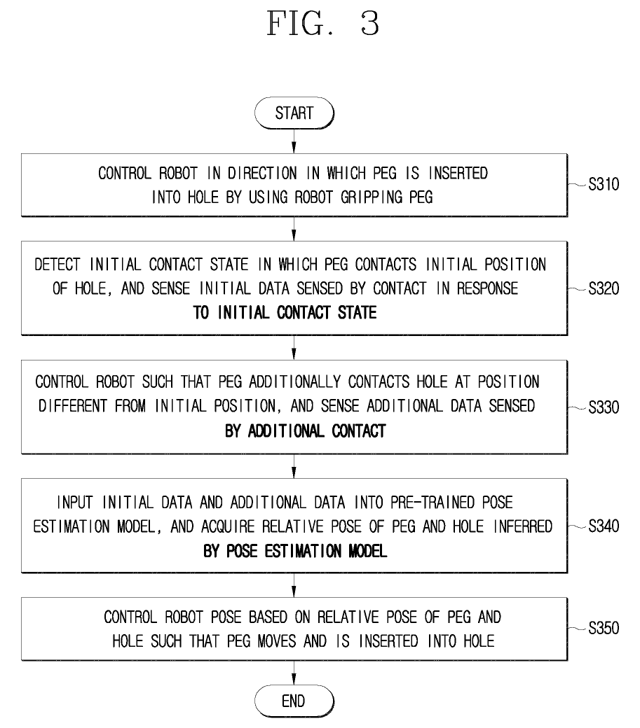

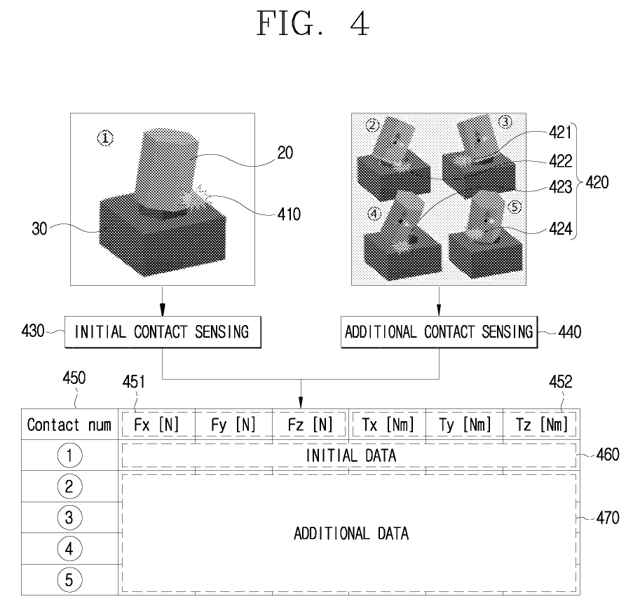

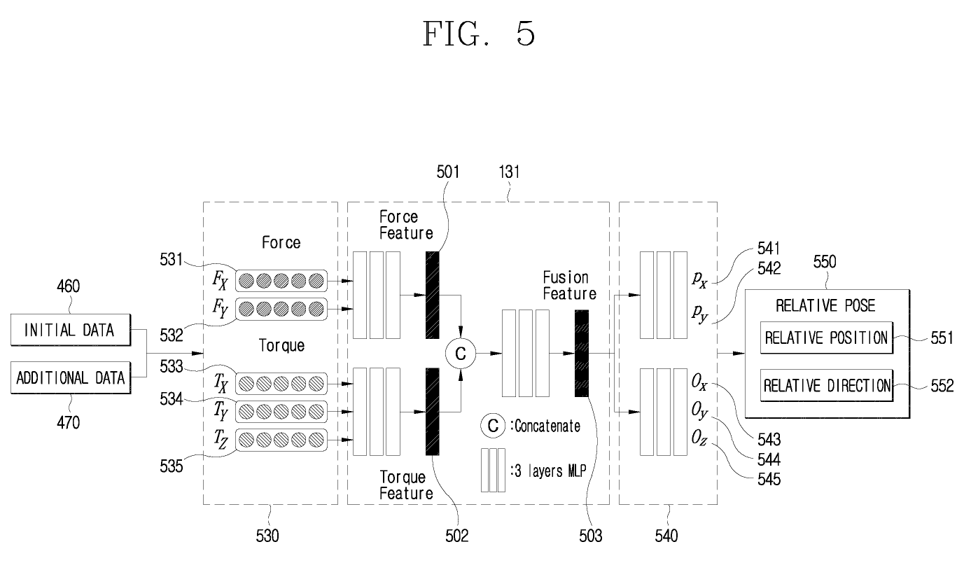

Hereinafter, with reference to FIG. 3 together with FIGS. 4 and 5, the method for controlling a robot pose using force/torque sensor-based pose estimation according to the present invention will be described in more detail. FIG. 3 is a flowchart for describing a method for controlling a robot pose using force/torque sensor-based pose estimation according to the present invention, FIG. 4 is a conceptual diagram for describing a process of sensing a contact state and sensing data according to the present invention, and FIG. 5 is a conceptual diagram for describing a process of inferring a relative pose of peg and hole by using a pose estimation model according to the present invention.

In the present invention, a process of controlling the robot in a direction in which the peg is inserted into the hole by using a robot gripping the peg may proceed (S310, see FIG. 3).

The control unit 130 according to the present invention may manipulate a manipulator provided in the robot 10 by using the robot controller 132. Further, the control unit 130 may control the robot 10 to grip the peg, move the peg in a direction in which the peg is inserted into the hole, thereby causing the peg and the hole into contact.

As described above, “hole” may mean an object including at least one hole (or opening) into which the peg may be inserted. In this case, in the present invention, insertion of the peg 20 into a hole (or opening) may also be understood as insertion of the peg 20 into the hole 30. Also, the contact of the peg 20 with a portion of an object including a hole (or opening) may also be understood as the contact of the peg 20 with the hole 30.

The control unit 130 may control a pose of the robot 10 such that the robot 10 grips the peg 20 and the peg 20 contacts the hole 30, and may control such that a preset magnitude (e.g., 10N) of force is applied in a direction (e.g., a Z-axis) in which the peg 20 is inserted into the hole 30. Further, the control unit 130 may sense at least one among force data and torque data generated by a force applied in a direction in which the peg 20 is inserted into the hole 30. Specifically, by using the sensor unit 140 provided in the robot 10, the control unit 130 may sense force data corresponding to a force in an X-axis direction, a force in a Y-axis direction, and a force in a Z-axis direction, which are generated by contact between the peg and the hole, and may sense torque data corresponding to a torque with respect to an X-axis (or, a turning (or twisting, rotational) force), a torque with respect to a Y-axis, and a torque with respect to a Z-axis.

For example, by using a 6-axis F/T (force/torque) sensor provided in the robot 10, the control unit 130 may sense the contact force generated as the peg 20 and the hole 30 come into contact. In this case, when the peg 20 contacts the hole 30, force and torque continuously occur, and in the present invention, an average of X-axis, Y-axis, and Z-axis values of force data and torque data in a predetermined section (e.g., 200 time step) may be used.

Meanwhile, in the present invention, a force may be measured as a positive-direction force when pushing an object in a direction of XYZ axes, and a torque may be sensed as a positive-direction torque according to a right-hand rule with respect to XYZ axes.

In the present invention, a process of detecting an initial contact state in which the peg 20 contacts an initial position of the hole 30, and sensing initial data sensed by contact in response to the initial contact state may proceed (S320, see FIG. 3).

As illustrated in FIG. 4, based on initial contact 410 in which the peg 20 initially contacts the hole 30, the control unit 130 may sense initial data 460 including at least one among force data 451 and torque data 452 generated by initial contact, in the initial contact state.

More specifically, through the sensor unit 140 provided in the robot 10, the control unit 130 may sense force data 451 including at least one among X-axis direction force data, Y-axis direction force data, and Z-axis direction force data. In addition, through the sensor unit 140 provided in the robot 10, the control unit 130 may sense torque data 452 including at least one among X-axis direction torque data, Y-axis direction torque data, and Z-axis direction torque data.

In the present invention, a process of controlling the robot such that the peg additionally contacts the hole in a position different from an initial position, and sensing additional data sensed by additional contact may proceed (S330, see FIG. 3).

By using the robot controller 132, the control unit 130 may control the robot 10 such that the peg 20 and the hole 30 come into additional contact in a position different from an initial position. Further, the control unit 130 may sense additional data 470 including force data 451 and torque data 452 generated by additional contact of the peg 20 and the hole 30 in the different position.

More specifically, the control unit 130 may sequentially rotate the peg by a preset number of times according to a preset direction. Here, “preset number of times” may mean a number of times of rotating a direction of the peg, by controlling the robot 10, for additional contact between the peg and the hole, and it may be understood that the preset number of times may be variously set. In this case, in the present invention, it is described that the robot 10 is controlled to sequentially rotate the peg according to a preset direction, however, the present invention is not limited thereto, and it may be understood that the robot 10 is controlled to sequentially move a position of the peg to a preset position.

Further, in response to each rotation of the peg sequentially rotating according to the preset direction, the control unit 130 may sense the additional data 470. As an example, by controlling the robot 10, the control unit 130 may rotate the peg 20 by a preset number of times (e.g., 4 times) in a preset direction (e.g., ±10° X-axis and Y-axis), and may perform additional contact 420 of the peg 20 and the hole 30. In this case, in response to each rotation of the peg sequentially rotating, by performing additional contact sensing 440, the control unit 130 may sense at least one among force data 451 and torque data 452 generated by additional contact between the peg 20 and the hole 30 at contact of each of a second contact 422, a third contact 421, a fourth contact 423, and a fifth contact 424. That is, by using the sensor unit 140 provided in the robot 10, the control unit 130 may sense the additional data 470 including force data 451 and torque data 452 corresponding to the preset number of times.

In the present invention, it is described that, in response to each rotation of the peg sequentially rotating, additional contact sensing 440 is performed, however, the present invention is not limited thereto, and performing additional contact sensing 440 in response to each movement of the peg sequentially moving may also be included. More specifically, the control unit 130 may control the robot such that the peg additionally contacts the hole in a position different from the initial position, and may sense additional data sensed by the additional contact, and may control the robot 10 such that contact occurs in a process of continuously moving by a pose inferred in a previous step.

For example, based on a relative pose of the peg 20 and the hole 30 inferred in an N-th contact of the peg 20, the control unit 130 may sense the additional data 470 with reference to an N+1-th contact performed as controlling a pose of the robot 10. Here, “N-th contact” may mean an arbitrary order or number of contact events generated in the process of controlling a robot pose according to the present invention.

Based on a relative pose of the peg 20 and the hole 30 inferred in the second contact 422, the control unit 130 may control a pose of the robot 10 such that the peg 20 and the hole 30 perform the third contact 421. More specifically, based on occurrence of the second contact event, without rotating in the preset direction based on the preset number of times, based on a relative pose of the peg 20 and the hole 30 inferred in the second contact 422, the control unit 130 may control a pose of the robot 10 such that the peg 20 and the hole 30 perform a third contact.

That is, the control unit 130 according to the present invention may sequentially rotate the peg by a preset number of times according to a preset direction, and based on completing a plurality of additional contacts, may infer a relative pose, and may control a pose of the robot 10. Differently from this, by using contact of the peg 20 and the hole 30 in a process of being continuously moved to a pose inferred in a previous step, the control unit 130 may infer a relative pose, and may also control a pose of the robot 10.

In the present invention, a process of inputting initial data and additional data into a pre-trained pose estimation model, and acquiring a relative pose of the peg and the hole inferred by the pose estimation model may proceed (S340, see FIG. 3).

As illustrated in FIG. 5, the control unit 130 may process at least one among initial data 460 and additional data 470 sensed by contact between the peg 20 and the hole 30 as input data 530 of the pre-trained pose estimation model 131.

The pose estimation model 131 according to the present invention may include a multi-layer-perceptron (MLP)-based pose estimation model that receives, as input, at least one among the initial data 460 and the additional data 470 and infers a relative pose of the peg 20 and the hole 30. Specifically, the control unit 130 may input the input data 530 including at least one among X-axis direction force data 531, Y-axis direction force data 532, X-axis direction torque data 533, Y-axis direction torque data 534, and Z-axis direction torque data 535 included in the initial data 460 and the additional data 470 to the pose estimation model 131.

In this case, in the present invention, since a Z-axis direction force included in the initial data 460 and the additional data 470 is controlled such that a preset magnitude (e.g., 10N) of force is applied by the robot 10, it may be understood that Z-axis direction force data is not used for inferring a relative pose 550 of the peg and the hole. In the present invention, it is described that Z-axis direction force data is not input to the pose estimation model 131, however, the present invention is not limited thereto, and force data including Z-axis direction force data may also be input.

Further, by inputting X-axis direction force data 531 and Y-axis direction force data 532 to a force encoder of the pose estimation model 131, the control unit 130 may extract a force feature vector (Force Feature, 501). Here, “force feature vector 501” may mean a feature vector extracted by identifying a correlation relationship between respective force data sensed at initial contact 410 and additional contact 420 between the peg 20 and the hole 30.

Also, by inputting X-axis direction torque data 533, Y-axis direction torque data 534, and Z-axis direction torque data 535 to a torque encoder of the pose estimation model 131, the control unit 130 may extract a torque feature vector (Torque Feature, 502). Here, “torque feature vector 502” may mean a feature vector extracted by identifying a correlation relationship between respective torque data sensed by initial contact 460 and additional contact 470 between the peg 20 and the hole 30.

The control unit 130 may generate a fusion feature vector (Fusion Feature, 503) by concatenating the extracted force feature vector 501 and the torque feature vector 502. Further, the control unit 130 may input the fusion feature vector 503 to a position decoder and an orientation decoder. Here, “a position decoder” may calculate a relative position 551 of the peg 20 and the hole 30 from the input fusion feature vector 503.

Specifically, by inputting the fusion feature vector 503 to the position decoder, the control unit 130 may calculate at least one among an X-axis relative position 541 and a Y-axis direction relative position 542 expressing a relative position 551 of the peg 20 and the hole from a center of the hole 30.

Also, “an orientation decoder” may calculate a relative direction 552 of the peg 20 and the hole 30 from the input fusion feature vector 503. More specifically, by inputting the fusion feature vector 503 to the orientation decoder, the control unit 130 may calculate at least one among an X-axis relative rotation direction 543, a Y-axis relative rotation direction 544, and a Z-axis relative rotation direction 545 expressing a relative direction 552 regarding how much the peg 20 and the hole 30 are rotated from the center of the hole 30.

At least one among an encoder and a decoder according to the present invention described above may be configured as a multilayer perceptron (MLP) structure. For example, at least one among the encoder and the decoder according to the present invention may be configured as a three layers MLP structure.

As described above, the control unit 130 may calculate a relative pose of the peg and the hole by using a coordinate system of the peg and a coordinate system of the hole. Specifically, in a state in which the peg is inserted into the hole, the control unit 130 may set a common origin of the coordinate system of the peg and the coordinate system of the hole, and by using the common origin, with respect to the hole 30, may infer how much the peg 20 is separated and how much the peg 20 is rotated. For example, by using the common origin, the control unit 130 may infer a relative pose 550 including at least one among a relative position 551 and a relative direction 552 of the peg 20 with respect to the hole 30.

In the above, by using at least one among force data and torque data, the pose estimation model 131 that infers a relative pose of the peg 20 and the hole has been described. Hereinafter, a process of training the pose estimation model 131 will be described.

For training of the pose estimation model 131, the control unit 130 may build training data in a virtual environment. Specifically, by using a virtual peg and a virtual hole corresponding to a plurality of different shapes in the virtual environment, the control unit 130 may train the pose estimation model 131.

For example, in the virtual environment, by using a three-dimensional model corresponding to a virtual peg corresponding to an arbitrary polygon shape and a virtual hole having the same shape as the virtual peg, the control unit 130 may train the pose estimation model 131. By contacting the virtual peg and the virtual hole, the control unit 130 may acquire at least one among virtual force data and virtual torque data in the virtual environment. By using training data including at least one among virtual force data and virtual torque data sensed by contact of the virtual peg and the virtual hole, the control unit 130 may train the pose estimation model 131.

Specifically, by using training data including at least one among virtual force data and virtual torque data, and ground-truth data including a ground-truth relative pose of the virtual peg and the virtual hole, the control unit 130 may train the pose estimation model 131.

In the present invention, it is described that the pose estimation model 131 is trained in the virtual environment, however, the present invention is not limited thereto, and by using data in various environments (e.g., an actual environment), the pose estimation model 131 may be trained, and it may be understood that training using data collected in the actual environment or mixed data is also possible.

In the present invention, a process of controlling a robot pose based on a relative pose of the peg and the hole such that the peg moves and is inserted into the hole may proceed (S350, see FIG. 3).

Based on completing additional contact of the peg 20 and the hole 30 of a preset number of times, the control unit 130 may rotate (or, move) a pose of the peg 20 to an initial pose corresponding to an initial contact state. Further, by using the initial pose and relative pose of the peg 20 and the hole 30, the control unit 130 may control the robot 10 such that the peg 20 is inserted into the hole 30.

For example, by using the robot controller 132, by reversely rotating (or, moving) the peg 20 by as much as a position and a direction corresponding to inferred relative pose in the initial pose, the control unit 130 may control the robot 10 to insert the peg 20 into the hole 30. That is, after inferring, by the control unit 130, a relative pose of the peg 20 and the hole 30 in the initial contact state, when moving the peg to coordinates obtained by subtracting coordinates corresponding to the relative pose from coordinates corresponding to the initial pose, coordinates corresponding to a relative pose of the peg 20 and the hole 30 may be aligned to an origin. By controlling at least one among a position and a direction of the peg 20 such that coordinates corresponding to a relative pose of the peg 20 and the hole 30 are aligned to the origin, the control unit 130 may insert the peg 20 into the hole 30. Here, “coordinates corresponding to a relative pose are aligned to the origin” may mean that a relative position and a relative direction of the peg 20 and the hole 30 with respect to the hole 30 are all zero, thereby meaning that the peg 20 is inserted into the hole 30.

Further, based on controlling a pose of the robot 10, the control unit 130 may determine whether the peg 20 is inserted into the hole 30, and based on not being inserted, may perform initial contact and additional contact, and may also repeatedly perform controlling a pose of the robot 10.

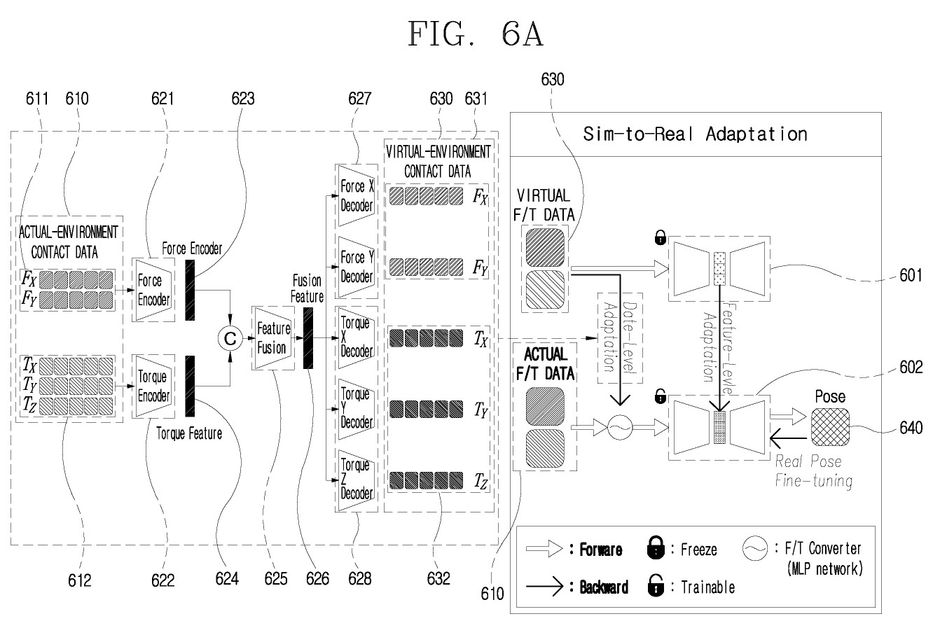

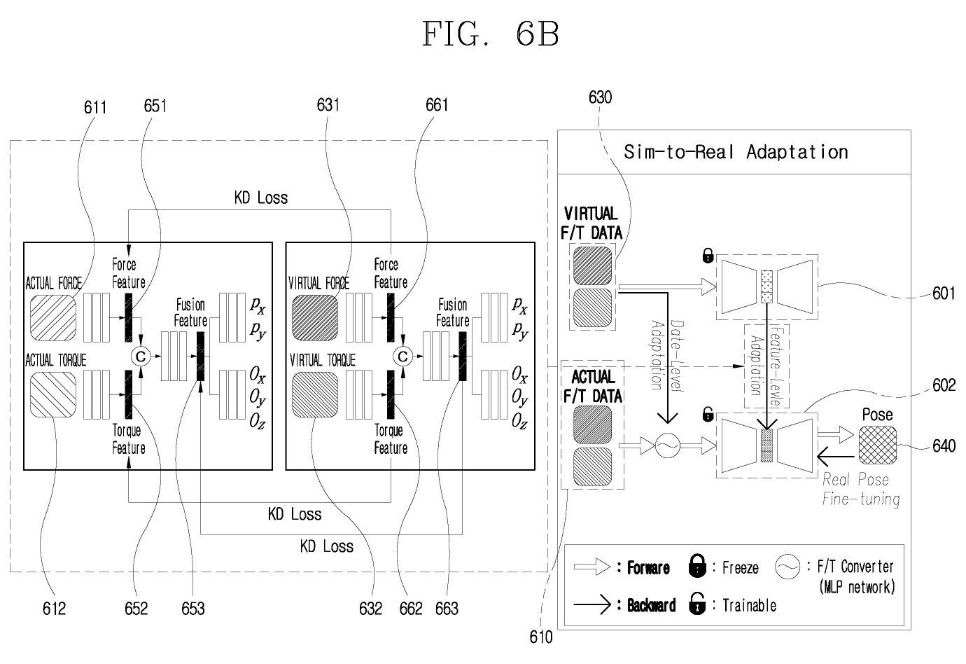

In the above, the method of, by inputting initial data and additional data sensed as the peg 20 contacts the hole 30, according to the present invention, into the pose estimation model 131, inferring a relative pose of the peg 20 and the hole 30, and controlling a robot pose based on a relative pose, has been described in detail. Hereinafter, with reference to FIGS. 6A and 6B, a method of, by using the pose estimation model trained in a virtual environment, updating the pose estimation model trained in an actual environment, and preventing performance degradation of the pose estimation model caused by a domain gap of the virtual environment and the actual environment, will be described. FIGS. 6A and 6B are conceptual diagrams for describing a Sim-to-Real adaptation process according to the present invention.

Meanwhile, the pose estimation model 131 according to the present invention may include a first pose estimation model trained in the virtual environment and a second pose estimation model trained in the actual environment. In this case, the first pose estimation model may infer a relative pose of the peg and the hole by using virtual contact data in the virtual environment, and the second pose estimation model may infer a relative pose of the peg and the hole by using actual contact data in the actual environment.

In the present invention, even when sensing force data and torque data by using the peg and the hole having the same shape in the virtual environment and the actual environment, an error may occur due to a domain gap of the virtual environment and the actual environment. Accordingly, in the present invention, force data and torque data of the virtual environment and force data and torque data of the actual environment may show different aspects under the same condition.

More specifically, unlike the virtual environment, in the actual environment, an error generated in the sensor unit 140 exists, and surface friction and the like according to material characteristics configuring the peg and the hole exist, thereby a difference of distribution with respect to force data and torque data respectively sensed in the virtual environment and the actual environment may occur.

Accordingly, the control unit 130 may update the second pose estimation model trained in the actual environment by using the first pose estimation model trained in the virtual environment. Here, “update” may mean a process of modifying parameters and a prediction method such that the pose estimation model corresponds to the actual environment while comparing data learned by the pose estimation model in the virtual environment with data of the actual environment. In the present invention, by updating the second pose estimation model trained in the actual environment by using the first pose estimation model trained in the virtual environment, a domain gap between the virtual environment and the actual environment may be reduced.

For example, through a process of data-level adaptation, the control unit 130 may reduce a domain gap of the actual environment and the virtual environment by converting actual data sensed in the actual environment into virtual data sensed in the virtual environment.

As illustrated in FIG. 6A, the control unit 130 may convert the actual contact data into the virtual data such that actual contact data including force data and torque data sensed by contact between the peg 20 and the hole 30 in the actual environment corresponds to virtual contact data. More specifically, by converting distribution characteristics of actual contact data sensed in the actual environment to be similar to distribution characteristics of virtual contact data sensed in the virtual environment, the control unit 130 may reduce a domain gap between the actual contact data and the virtual contact data.

For example, in order to convert actual contact data into the virtual data, the control unit 130 may input the actual force data 611 included in actual contact data 610 into a force encoder 621. By using the force encoder 621, the control unit 130 may extract an actual force feature vector 623 from the actual force data 611. Also, the control unit 130 may input the actual torque data 612 included in the actual contact data 610 into the force encoder 621. By using a torque encoder 622, the control unit 130 may extract an actual torque feature vector 624 from the actual torque data 612.

By concatenating the extracted actual force feature vector 623 and actual torque feature vector 624, the control unit 130 may generate an actual fusion feature vector (Fusion Feature, 626). Further, the control unit 130 may input the actual fusion feature vector 626 into a force decoder 627 and a torque decoder 628.

Specifically, by inputting the actual fusion feature vector 626 into the force decoder 627, the control unit 130 may convert the actual force data 611 into virtual force data 631. Also, by inputting the actual fusion feature vector 626 into the torque decoder 628, the control unit 130 may convert the actual torque data 612 into virtual torque data 632. That is, in order to reduce a domain gap of the actual environment and the virtual environment, the control unit 130 may convert actual contact data into virtual contact data such that the actual contact data 610 corresponds to virtual contact data 630.

Further, through a feature-level adaptation process, by using a virtual feature vector extracted in the first pose estimation model and an actual feature vector extracted in the second pose estimation model, the control unit 130 may reduce a domain gap of the actual environment and the virtual environment.

More specifically, the control unit 130 may train the second pose estimation model such that the second pose estimation model trained in the actual environment extracts a feature vector similar to the first pose estimation model trained in the virtual environment.

For example, by using a knowledge distillation technique, the control unit 130 may correspond a virtual feature vector extracted in the first pose estimation model 601 and an actual feature vector extracted in the second pose estimation model 602. Here, “a knowledge distillation technique” may mean a technique in which a student model learns knowledge of a teacher model through a teacher model and a student model.

A teacher model according to the present invention may mean the first pose estimation model 601, and a student model may mean the second pose estimation model 602. In this case, the second pose estimation model 602 may be trained to infer a relative pose 640 of the peg 20 and the hole 30 based on actual contact data according to an operation method of the first pose estimation model.

As illustrated in FIG. 6B, the control unit 130 may train the second pose estimation model such that an actual feature vector extracted in the second pose estimation model is extracted similarly to a virtual feature vector extracted in the first pose estimation model. For example, by inputting actual force data 611 into a force encoder, the control unit 130 may extract an actual force feature vector 651, and by inputting virtual force data 631 into the force encoder, the control unit 130 may extract a virtual force feature vector 661. Further, the control unit 130 may train the second pose estimation model 602 to reduce loss of a loss function (e.g., KD Loss) between the actual force feature vector 651 and a virtual force feature vector 663.

Also, by inputting actual torque data 612 into a torque encoder, the control unit 130 may extract an actual torque feature vector 652, and by inputting virtual torque data 632 into the torque encoder, the control unit 130 may extract a virtual torque feature vector 662. Further, the control unit 130 may train the second pose estimation model 602 to reduce loss of a loss function (e.g., KD Loss) between the actual torque feature vector 652 and the virtual torque feature vector 662.

By concatenating the actual force feature vector 651 and the actual torque feature vector 652, the control unit 130 may generate an actual fusion feature vector 653. Also, by concatenating the virtual force feature vector 661 and the actual torque feature vector 662, the control unit 130 may generate a virtual fusion feature vector 663. The control unit 130 may train the second pose estimation model 602 to reduce loss of a loss function (e.g., KD Loss) between the actual fusion feature vector 653 and the virtual fusion feature vector 663.

That is, the control unit 130 may convert actual contact data 610 such that the actual contact data 610 corresponds to virtual contact data 630, and by using the knowledge distillation technique, may correspond a virtual feature vector extracted in the first pose estimation model 601 and an actual feature vector extracted in the second pose estimation model 602. Through this, by using the first pose estimation model 601, the control unit 130 may update the second pose estimation model 602 such that the second pose estimation model 602 operates like the first pose estimation model 601.

Further, by using actual contact data collected in the actual environment, the control unit 130 may fine-tune the second pose estimation model 602 to reflect characteristics of the actual environment and reduce a domain gap of the virtual environment and the actual environment.

More specifically, by using the actual contact data, the control unit 130 may update parameters (e.g., weights) of the second pose estimation model 602 updated by the first pose estimation model 601. For example, by using a relative pose of the peg 20 and the hole 30 inferred by using the actual contact data and ground-truth relative pose, the control unit 130 may fine-tune the second pose estimation model 602.

More specifically, based on loss of a relative pose of the peg 20 and the hole 30 inferred by using the second pose estimation model 602 and a ground-truth relative pose, the control unit 130 may fine-tune parameters of the second pose estimation model. As an example, for an entire network of the second pose estimation model, the control unit 130 may fine-tune parameters. As another example, the control unit 130 may fine-tune parameters of at least one among an encoder and a decoder configuring the second pose estimation model 602.

That is, by fine-tuning the second pose estimation model 602 by using actual contact data, the control unit 130 may infer a relative pose 640 of the peg 20 and the hole 30 in the actual environment.

The Sim-to-Real adaptation process according to the present invention is not a conceptual training strategy, but a concrete model update procedure that modifies parameters of a pose estimation model deployed in an actual robot system, based on correspondence between virtual-domain features and actual-domain features.

Through this process, the robot control system adapts its internal estimation behavior to physical environments without requiring reconstruction of the control logic.

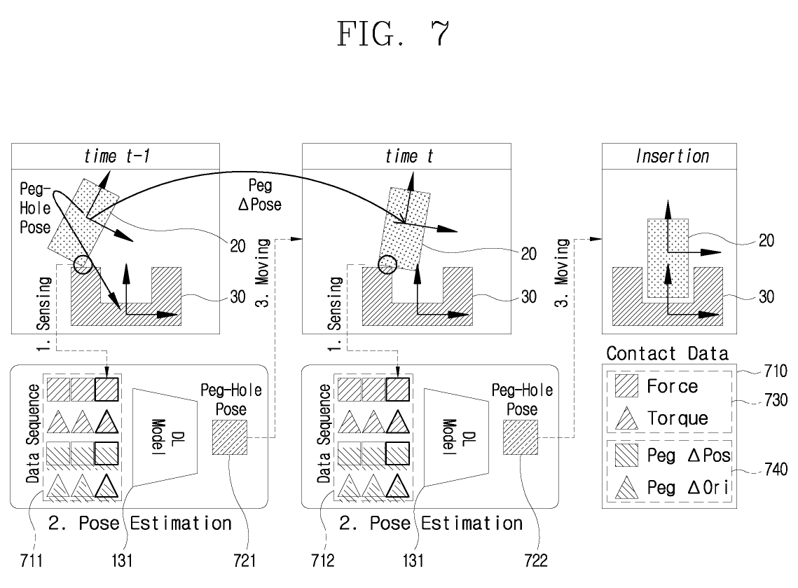

In the above, by using the first pose estimation model trained in the virtual environment according to the present invention, updating the second pose estimation model trained in the actual environment, and preventing performance degradation of the second pose estimation model caused by a domain gap of the virtual environment and the actual environment, has been described in detail. Hereinafter, with reference to FIG. 7, an overall method of, by repeatedly inferring a relative pose of the peg and the hole, gradually controlling a robot pose such that the peg is inserted into the hole, will be described in detail. FIG. 7 is a conceptual diagram for describing a process of controlling a robot pose through force/torque sensor-based continuous pose estimation according to the present invention.

Meanwhile, in the present invention, by inputting movement amount of the peg 20 moved by the robot 10 and force data and torque data sensed by contact between the peg 20 and the hole 30 into a pre-trained pose estimation model, the control unit 130 may infer a relative pose of the peg and the hole. Further, the present invention may sequentially control movement of the peg while comparing a relative pose with a target pose.

Previously, since a process of inferring a relative pose of the peg and the hole by using force data and torque data according to the present invention has been described in detail, hereinafter, in order to prevent duplication of description, the process will be briefly described.

As illustrated in FIG. 7, in the present invention, the control unit 130 may sense first contact data 710 generated by first contact of the peg 20 and the hole 30, and may input a sequence 711 of the first contact data into the pose estimation model 131. Here, a sequence 710 of contact data may include contact data 730 including at least one among force data and torque data, and peg movement amount 740 including at least one among a position change amount of the peg 20 and a direction change amount of the peg 20.

The robot pose control according to the present invention is executed as a closed-loop control process in which contact sensing, relative pose estimation, and robot motion update are repeatedly performed.

In this closed-loop control process, a relative pose inferred at a previous contact is reused to determine subsequent robot motion, such that the peg incrementally converges toward a target pose corresponding to insertion of the peg into the hole.

Further, in the present invention, based on a first relative pose 721 of the peg 20 and the hole 30 inferred from the pose estimation model 131, the control unit 130 may control a pose of the robot 10. In this case, the first relative pose 721 of the peg 20 and the hole 30 according to a changed position and direction of the peg may be compared with a target pose. Here, “a target pose” may mean a relative pose of the peg 20 and the hole 30 corresponding to insertion of the peg 20 and the hole 30.

In the present invention, it may be determined whether a relative pose satisfies the target pose, and according to a determination result, different processes may be performed. For example, based on a relative pose satisfying the target pose, it may be determined that the peg 20 is inserted into the hole 30, and controlling a pose of the robot 10 may be terminated. On the other hand, based on the first relative pose 721 not satisfying the target pose, a second contact data sequence 712 by second contact of the peg 20 moved by the robot 10 and the hole 30 may be sensed. Further, by inputting the second contact data sequence 712 into the pose estimation model 131, the control unit 130 may infer a second relative pose 722 of the peg 20 and the hole 30.

Further, in the present invention, based on the second relative pose 722, by controlling a pose of the robot 10 again, the control unit 130 may insert the peg 20 into the hole 30. That is, it may be understood that the present invention may gradually control a robot pose until a relative pose of the peg 20 and the hole 30 reaches the target pose and the peg is inserted into the hole.

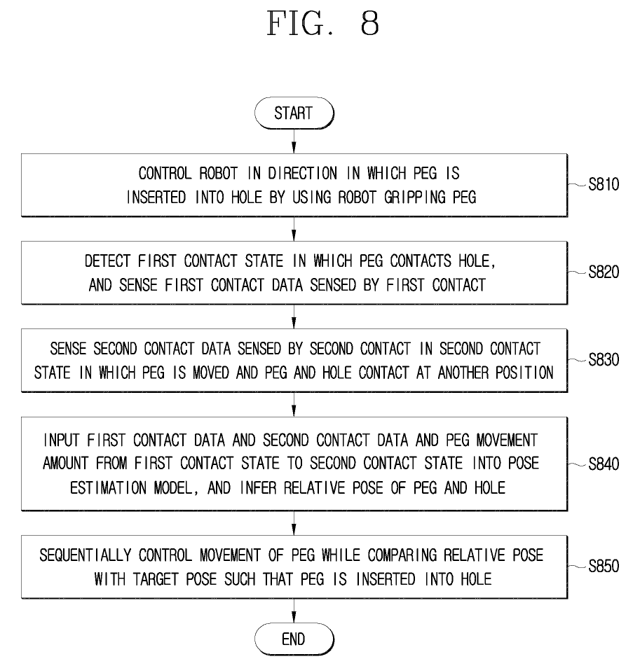

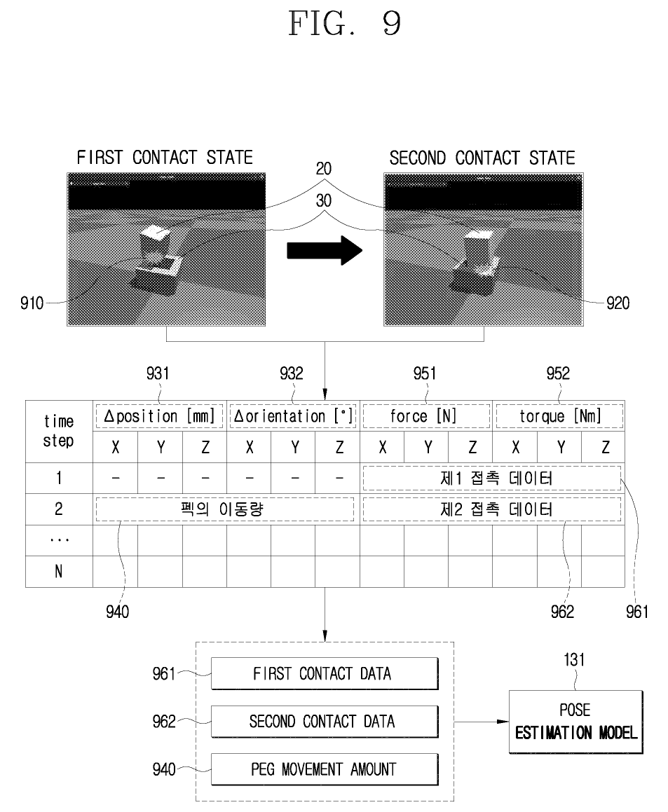

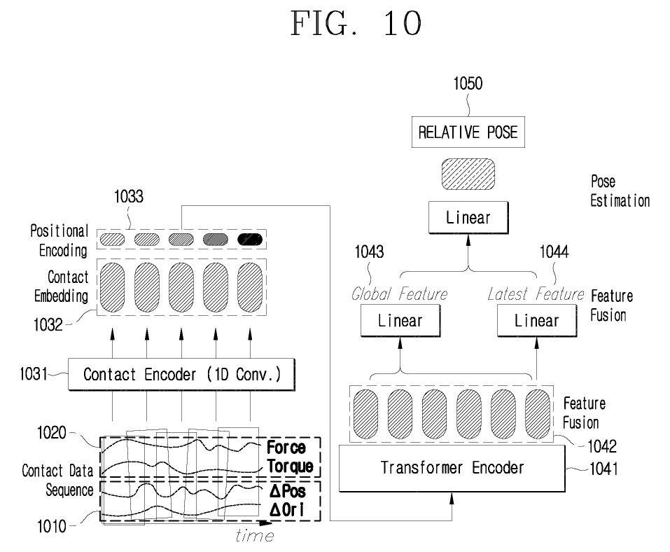

Hereinafter, with reference to FIGS. 8, 9 and 10, a method of, by repeatedly inferring a relative pose of the peg and the hole, gradually controlling a robot pose such that the peg is inserted into the hole, will be described in more detail. FIG. 8 is a flowchart for describing a method for controlling a robot pose through force/torque sensor-based continuous pose estimation according to the present invention, FIG. 9 is a conceptual diagram for describing a process of contact data sensing and peg movement amount calculation according to the present invention, and FIG. 10 is a conceptual diagram for describing a pose estimation model according to the present invention.

In the present invention, a process of controlling the robot in a direction in which the peg is inserted into the hole by using the robot gripping the peg may proceed (S810, see FIG. 8).

As described above, the control unit 130 may manipulate the manipulator provided in the robot 10 by using the robot controller 132. Further, the control unit 130 may control the robot 10 to grip the peg, move the peg in a direction in which the peg is inserted into the hole, thereby causing the peg and the hole into contact. Further, the control unit 130 may detect a contact state in which the peg contacts the hole, and may sense contact force generated by contact. Since a process in which the control unit 130 senses force data and torque data by contact by using the sensor unit 140 provided in the robot 10 has been described in detail above, hereinafter, in order to prevent duplicate description, the process will be omitted.

In the present invention, a process of detecting a first contact state in which the peg contacts the hole, and sensing first contact data sensed by first contact may proceed (S820, see FIG. 8).

As illustrated in FIG. 9, based on first contact 910 of the peg 20 with the hole 30 at a first position of the hole 30, the control unit 130 may sense first contact data 961 including at least one among force data 951 and torque data 952 generated by the first contact 910.

Further, the control unit 130 may control a pose of the robot 10 such that the peg 20 and the hole 30 perform second contact 920 at a second position different from the first position of the hole 30. More specifically, by inputting contact data and peg movement amount before the first contact into the pose estimation model, the control unit 130 may infer a relative pose of the peg 20 and the hole 30. Based on a first relative pose inferred of the peg 20 and the hole 30, the control unit 130 may control a pose of the robot 10 such that the peg 20 and the hole 30 perform the second contact 920 at a second position different from the first position of the hole 30.

In the present invention, a process of, in a second contact state in which the peg is moved and the peg and the hole contact at another position, sensing second contact data sensed by second contact may proceed (S830, see FIG. 8).

By controlling the robot 10, by moving (or, rotating) at least one among a position and a direction of the peg 20, the control unit 130 may cause the peg 20 to perform the second contact 920 with the hole 30 at a second position different from the first position. Further, based on the second contact 920 of the peg 20 with the hole 30, in the second contact state, the control unit 130 may sense second contact data 962 including at least one among force data 951 and torque data 952 generated by the second contact.

Further, the control unit 130 may calculate movement amount of the peg 20 moved (or, rotated) from the first position to the second position by the robot 10. More specifically, by using the sensor unit 140 provided in the robot 10, the control unit 130 may calculate movement amount of the peg 20. As an example, by using a motor encoder configuring the sensor unit 140, the control unit 130 may calculate a rotation amount of a manipulator joint provided in the robot 10. Further, by calculating a movement path of the gripper gripping the peg 20 from the rotation amount of the joint, the control unit 130 may calculate peg movement amount 940.

As another example, by using an inertial sensor included in the sensor unit 140, the control unit 130 may measure a pose change of the robot 10 and may calculate peg movement amount 940. A peg movement amount 940 calculation method according to the present invention is not limited to the examples described above, and may further include various methods of measuring a position change amount of the peg and a direction change amount of the peg.

The peg movement amount 940 according to the present invention may include at least one among position change amount 931 data of the peg 20 and direction change amount 932 data of the peg 20 due to movement of the peg 20 from the first contact state to the second contact state.

Further, the control unit 130 may process at least one among the first contact data 961, the second contact data 962, and peg movement amount 940 sensed by contact between the peg 20 and the hole 30 as input data of a pre-trained pose estimation model 131.

In the present invention, a process of inputting the first contact data and the second contact data and peg movement amount from the first contact state to the second contact state into the pose estimation model, and inferring a relative pose of the peg and the hole, may proceed (S840, see FIG. 8).

As illustrated in FIG. 10, the pose estimation model 131 according to the present invention may include a transformer-based pose estimation model that receives a contact data sequence including contact data 1010 sensed by contact between the peg 20 and the hole 30 and peg movement amount 1020, and infers a relative pose of the peg 20 and the hole 30.

The control unit 130 may process the contact data 1010 and the peg movement amount 1020 as an input of a contact encoder 1031. Here, “the contact encoder 1031” may extract continuous features such as a change over time of force data and torque data through 1D Convolution.

More specifically, by embedding the contact data 1010 and the peg movement amount 1020, the control unit 130 may generate a contact embedding vector 1032. Further, through position encoding 1033, the control unit 130 may add order information to the contact embedding vector 1032 such that the pose estimation model may consider an order of a contact data sequence.

Further, the control unit 130 may process the contact embedding vector 1032 as an input of a transformer encoder 1041. By using the transformer encoder 1041, the control unit 130 may extract a feature sequence 1042 from the contact embedding vector 1032. Here, “a feature sequence 1042” may mean a sequence of feature vectors extracted by processing input data.

By combining (feature Fusion) a global feature vector 1043 including features of an entirety of the feature sequence 1042 and a last feature vector 1044, the control unit 130 may generate a fusion feature vector. Here, “the fusion feature vector” may be understood as a feature vector in which, together with features corresponding to an entirety of the feature sequence 1042, features of a last contact data and a last peg movement amount are reflected. Further, the pose estimation model 131 may infer a relative pose of the peg 20 and the hole 30 from the fusion feature vector. More specifically, by calculating at least one among a relative position and a relative direction of the peg 20 and the hole 30 included in the fusion feature vector, the pose estimation model 131 may infer a relative pose of the peg 20 and the hole 30.

Training of a transformer-based pose estimation model according to the present invention, as described above, may be performed by using a virtual hole and a virtual peg in a virtual environment. Since a training process of the pose estimation model has been described in detail above, in order to prevent duplicate description, description of a training process of the transformer-based pose estimation model will be omitted.

In the present invention, a process of sequentially controlling movement of the peg while comparing a relative pose with a target pose such that the peg is inserted into the hole may proceed (S850, see FIG. 8).

As described above, by using the robot controller 132, by reversely rotating (or, moving) the peg 20 by as much as a position and a direction corresponding to a relative pose inferred in a previous pose, the control unit 130 may control the robot 10 to insert the peg 20 into the hole 30. That is, after inferring a relative pose of the peg 20 and the hole 30 in a previous contact state, the control unit 130 may move the peg to coordinates obtained by subtracting coordinates corresponding to the relative pose from coordinates corresponding to the previous pose.

Further, in response to movement of the peg 20, the control unit 130 may determine whether a relative pose of the peg 20 and the hole 30 satisfies the target pose. As described above, a target pose according to the present invention may mean a relative pose of the peg 20 and the hole 30 corresponding to insertion of the peg 20 and the hole 30.

By determining whether a relative pose of the peg 20 and the hole 30 satisfies (or, reaches) the target pose, and by using a determination result, the control unit 130 may continuously change a pose of the robot 10 until the relative pose satisfies the target pose.

More specifically, according to the determination result, the control unit 130 may perform different robot pose controlling processes. For example, based on first contact of the peg 20 and the hole 30, by using a pre-trained pose estimation model, the control unit 130 may infer a relative pose of the peg 20 and the hole 30 based on the first contact of the peg 20 and the hole 30. Further, based on the inferred first relative pose, the control unit 130 may control a pose of the robot 10 such that the peg 20 is inserted into the hole 30.

In this case, based on a second relative pose of the peg 20 and the hole 30 moved (or, rotated) by the robot 10 satisfying the target pose, the control unit 130 may determine that the peg 20 is inserted into the hole 30 by second contact. Further, based on the peg 20 being inserted into the hole 30, the control unit 130 may perform a first process of terminating controlling a pose of the robot 10.

On the other hand, based on a second relative pose of the peg 20 moved (or, rotated) by the robot 10 and the hole 30 not satisfying the target pose, by using a pre-trained pose estimation model 131, the control unit 130 may infer the second relative pose and may perform a second process of controlling a pose of the robot 10 again.

More specifically, the control unit 130 may sense a second contact data sequence 712 by second contact of the peg 20 moved by the robot 10 and the hole 30. Further, by inputting the second contact data sequence 712 into the pose estimation model 131, the control unit 130 may infer a second relative pose 722 of the peg 20 and the hole 30.

Further, in the present invention, based on the second relative pose 722, by controlling a pose of the robot 10 again, the control unit 130 may control a pose of the robot 10 again such that the peg 20 is inserted into the hole 30. That is, in the present invention, by determining whether a relative pose of the peg 20 and the hole 30 satisfies the target pose, and by using the determination result, by linking and performing continuous contact, inferring a relative pose, and movement of the peg 20 until the relative pose reaches the target pose, the control unit 130 may control a pose of the robot 10 such that the peg 20 is inserted into the hole 30.

The method and system for controlling a robot pose using force/torque sensor-based pose estimation according to the present invention, by estimating a relative pose of the peg and the hole by using at least one among force data and torque data sensed by contact between the peg and the hole, may minimize performance degradation due to external environment factors, and may improve assembly performance of a robot in various industrial sites.

Further, the method and system for controlling a robot pose using force/torque sensor-based pose estimation according to the present invention, by updating the pose estimation model applied to the actual environment by using the pose estimation model trained in the virtual environment, may perform a high degree-of-freedom peg-in-hole task for a new shape not trained in the actual environment.

Further, the method and system for controlling a robot pose using force/torque sensor-based pose estimation according to the present invention, by training the pose estimation model by using the peg and the hole having various shapes in the virtual environment, may replace a process of directly collecting data in the actual environment, and may minimize cost and time required for building the pose estimation model.

Meanwhile, the present invention described above may be executed by one or more processes on a computer and implemented as a program that may be stored on a computer-readable medium (or recording medium).

Further, the present invention described above may be implemented as computer-readable code or instructions on a medium in which a program is recorded. That is, the present invention may be provided in the form of a program.

Meanwhile, the computer-readable medium includes all kinds of recording devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy discs, optical data storage devices, and the like.

Further, the computer-readable medium may be a server or cloud storage that includes storage and that the electronic device is accessible through communication. In this case, the computer may download the program according to the present invention from the server or cloud storage, through wired or wireless communication.

Further, in the present invention, the computer described above is an electronic device equipped with a processor, that is, a central processing unit (CPU), and is not particularly limited to any type.

Meanwhile, it should be appreciated that the detailed description is interpreted as being illustrative in every sense, not restrictive. The scope of the present invention should be determined based on the reasonable interpretation of the appended claims, and all of the alternations within the equivalent scope of the present invention belong to the scope of the present invention.

What is claimed is:

1. A method for controlling a robot pose using force/torque sensor-based pose estimation, the method comprising:
controlling a robot in a direction in which a peg is inserted into a hole by using the robot gripping the peg;
detecting an initial contact state in which the peg contacts an initial position of the hole, and sensing initial data sensed by the contact in response to the initial contact state;
controlling the robot such that the peg additionally contacts the hole at a position different from the initial position, and sensing additional data sensed by the additional contact;
inputting the initial data and the additional data into a pre-trained pose estimation model, and acquiring a relative pose of the peg and the hole inferred by the pose estimation model; and
controlling the pose of the robot based on the relative pose of the peg and the hole such that the peg is moved and inserted into the hole.

2. The method of claim 1, wherein the sensing of the additional data comprises:
sequentially rotating the peg by a preset number of times according to a preset direction; and
sensing the additional data in response to each rotation of the peg sequentially rotating according to the preset direction.

3. The method of claim 2, wherein the initial data and the additional data comprise at least one among force data and torque data generated in a contact state of the peg and the hole.

4. The method of claim 1, comprising:
training the pose estimation model by using a virtual peg and a virtual hole corresponding to a plurality of different shapes in a virtual environment,
wherein, in the training, by using training data including at least one among virtual force data and virtual torque data sensed by contact of the virtual peg and the virtual hole and ground-truth data including a ground-truth relative pose of the virtual peg and the virtual hole, the pose estimation model is trained.

5. The method of claim 4, wherein the pose estimation model comprises at least one among a first pose estimation model trained in the virtual environment and a second pose estimation model trained in an actual environment, and
wherein the first pose estimation model infers the relative pose of the peg and the hole by using virtual contact data in the virtual environment, and the second pose estimation model infers the relative pose of the peg and the hole by using actual contact data in the actual environment.

6. The method of claim 5, further comprising:
updating the second pose estimation model by using the first pose estimation model.

7. The method of claim 6, wherein the updating comprises:
converting the actual contact data into the virtual contact data such that the actual contact data corresponds to the virtual contact data;
corresponding, by using a knowledge distillation technique, a virtual feature vector extracted in the first pose estimation model and an actual feature vector extracted in the second pose estimation model; and
fine-tuning the second pose estimation model by using the actual contact data.

8. The method of claim 1, wherein the sensing of the additional data comprises:
sensing the additional data with reference to an N+1-th contact performed as the robot pose is controlled based on the relative pose of the peg and the hole inferred at an N-th contact of the peg.

9. The method of claim 8,
wherein the sensing of the additional data comprises sensing the additional data while the peg is moved toward a pose inferred based on the relative pose acquired at a previous contact.

10. The method of claim 1,
wherein the initial data and the additional data are sensed by a force/torque sensor provided in a manipulator of the robot gripping the peg.

11. The method of claim 3,
wherein the force data comprise force components in X-axis and Y-axis directions, and the torque data comprise torque components with respect to X-axis, Y-axis, and Z-axis directions.

12. The method of claim 1,
wherein the pose estimation model comprises a force encoder configured to extract a force feature vector from the force data and a torque encoder configured to extract a torque feature vector from the torque data.

13. The method of claim 11,
wherein the pose estimation model further comprises a fusion module configured to concatenate the force feature vector and the torque feature vector to generate a fusion feature vector, and at least one decoder configured to infer the relative pose of the peg and the hole from the fusion feature vector.

14. The method of claim 1,
wherein the relative pose of the peg and the hole comprises at least one of a relative position and a relative orientation of the peg with respect to the hole defined in a coordinate system of the hole.

15. The method of claim 1,
wherein controlling the pose of the robot based on the relative pose comprises reversely moving or rotating the peg by an amount corresponding to the relative pose such that the relative position and the relative orientation of the peg with respect to the hole are reduced.

16. The method of claim 1,
wherein controlling the pose of the robot based on the relative pose comprises repeatedly inferring the relative pose of the peg and the hole and incrementally updating at least one of a position and an orientation of the peg until a target pose corresponding to insertion of the peg into the hole is satisfied.

17. A system for controlling a robot pose using force/torque sensor-based pose estimation, the system comprising:
a communication unit configured to communicate with a robot; and
a control unit configured to control the robot in a direction in which a peg is inserted into a hole by using the robot gripping the peg,
wherein the control unit:
detects an initial contact state in which the peg contacts an initial position of the hole;
senses initial data sensed by the contact in response to the initial contact state;
controls the robot such that the peg additionally contacts the hole at a position different from the initial position;
senses additional data sensed by the additional contact;
inputs the initial data and the additional data into a pre-trained pose estimation model;
acquires a relative pose of the peg and the hole inferred by the pose estimation model; and
controls the pose of the robot based on the relative pose of the peg and the hole such that the peg is moved and inserted into the hole.

18. A method for controlling a robot pose using force/torque sensor-based pose estimation, the method comprising:
controlling a robot in a direction in which a peg is inserted into a hole by using the robot gripping the peg;
detecting a first contact state in which the peg contacts the hole, and sensing first contact data sensed by the first contact;
sensing second contact data sensed by second contact in a second contact state in which the peg is moved and the peg and the hole contact at another position;
inferring a relative pose of the peg and the hole by inputting the first contact data and the second contact data and peg movement amount from the first contact state to the second contact state into a pose estimation model; and
sequentially controlling movement of the peg while comparing the relative pose with a target pose, such that the peg is inserted into the hole.

19. The method of claim 10, wherein the peg movement amount comprises at least one among position change amount data of the peg and direction change amount data of the peg due to movement of the peg from the first contact state to the second contact state.

20. The method of claim 11, wherein the sequential controlling of the movement of the peg comprises:
determining, in response to the movement of the peg, whether the relative pose of the peg and the hole satisfies the target pose; and
continuously changing a robot pose until the relative pose satisfies the target pose by using a determination result.
